(19) United States
(12) Patent Application Publication
(10) Pub. No.: US 2026/0365010 A1
(43) Pub. Date: Nov. 19, 2026

(54) AIR INTAKE DUCT FOR VEHICLE AND VEHICLE

(71) Applicant: Isuzu Motors Limited, Yokohama-shi (JP)

(72) Inventors: Chiaki HASHIOKA, Fujisawa-shi (JP); Yusuke AKATSU, Fujisawa-shi (JP)

(73) Assignee: Isuzu Motors Limited, Yokohama-shi (JP)

(21) Appl. No.: 19/572,987

(22) Filed: Mar. 20, 2026

(30) Foreign Application Priority Data
May 14, 2025 (JP) 2025-081292

(51) Int. Cl. B60K 13/02; F02M 35/04

(52) U.S. Cl. CPC B60K 13/02; F02M 35/044

(57) ABSTRACT

An air intake duct includes: an intake duct main body provided on one side in a left-right direction on a back side of a cab of a vehicle; a first guide portion provided on an inner wall of the intake duct main body, catching water taken into the intake duct main body and guiding the water downward; a first tank accumulating the water caught and guided by the first guide portion; a second guide portion provided below the first guide portion on the inner wall of the intake duct main body, catching the water taken into the intake duct main body and guiding the water downward; and a second tank accumulating the water caught and guided by the second guide portion upon entry of the water from an air intake port.

### CROSS-REFERENCE TO RELATED APPLICATION

This application is based upon and claims the benefit of priority from prior Japanese Patent Application No. 2025-081292, filed May 14, 2025, the entire contents of which are incorporated herein by reference.

### FIELD

The present invention relates generally to an air intake duct for a vehicle, and a vehicle.

### BACKGROUND

For example, Jpn. Pat. Appln. KOKAI Publication No. 2017-94794 discloses an air intake duct (intake vertical duct) for a vehicle having beads on an intake port side.

### SUMMARY

According to an aspect of the invention, an air intake duct according to an embodiment includes: an intake duct main body provided on one side in a left-right direction on a back side of a cab of a vehicle, the intake duct main body including an intake port that opens toward the one side of the vehicle, and drawing air from the intake port to introduce the air toward an engine on a lower side of the cab; a first guide portion provided on an inner wall of the intake duct main body, the first guide portion including one or more first ribs in which an upper side is closer to the intake port than a lower side, the first ribs catching water taken into the intake duct main body through the intake port from the one side and guiding the water downward; a first tank provided on an other side opposite to the one side and below the first guide portion, and accumulating the water caught and guided by the first guide portion upon entry of the water from the intake port; a second guide portion provided below the first guide portion on the inner wall of the intake duct main body, the second guide portion including one or more second ribs in which a lower side is closer to the intake port than an upper side, the second ribs catching the water taken into the intake duct main body through the intake port from the one side and guiding the water downward; and a second tank provided on the one side and below the second guide portion, and accumulating the water caught and guided by the second guide portion upon entry of the water from the intake port.

### BRIEF DESCRIPTION OF THE DRAWINGS

FIG. 1 is a schematic view showing part of a vehicle in which an air intake duct is disposed on a right rear side of a cab.

FIG. 2 is a schematic perspective view of an air intake duct according to a first embodiment as viewed from a right rear side of a vehicle.

FIG. 3 is a schematic perspective view of the air intake duct shown in FIG. 2 as viewed from a right front side of the vehicle.

FIG. 4 is a schematic view of the air intake duct shown in FIGS. 2 and 3 as viewed from the rear side.

FIG. 5 is a schematic view of the air intake duct shown in FIGS. 2 to 4 as viewed from the front side.

FIG. 6 is a schematic cross-sectional view taken along line VI-VI in FIG. 4.

FIG. 7 is a schematic perspective view of the view shown in FIG. 6 as viewed from a slightly right front side with respect to FIG. 6.

FIG. 8 is a schematic view of an air intake duct according to a second embodiment as viewed from the front side.

FIG. 9 is a cross-sectional view taken along line IX-IX in FIG. 8.

### DETAILED DESCRIPTION

Hereinafter, preferred embodiments will be described with reference to the drawings.

### First Embodiment

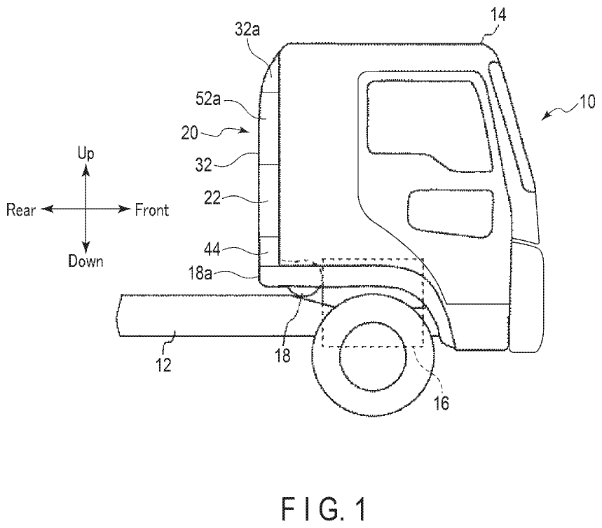

An air intake duct (intake vertical duct) 20 of a vehicle 10 according to a first embodiment will be described with reference to FIGS. 1 to 7.

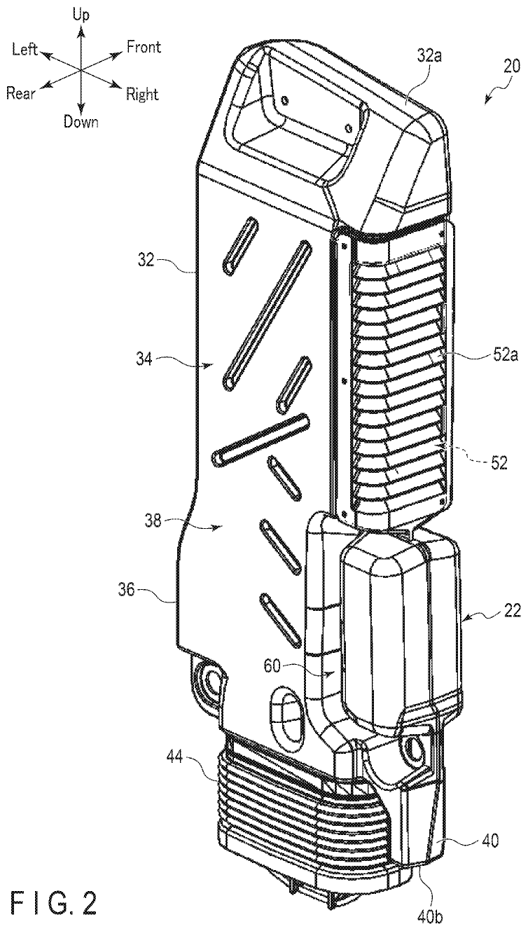

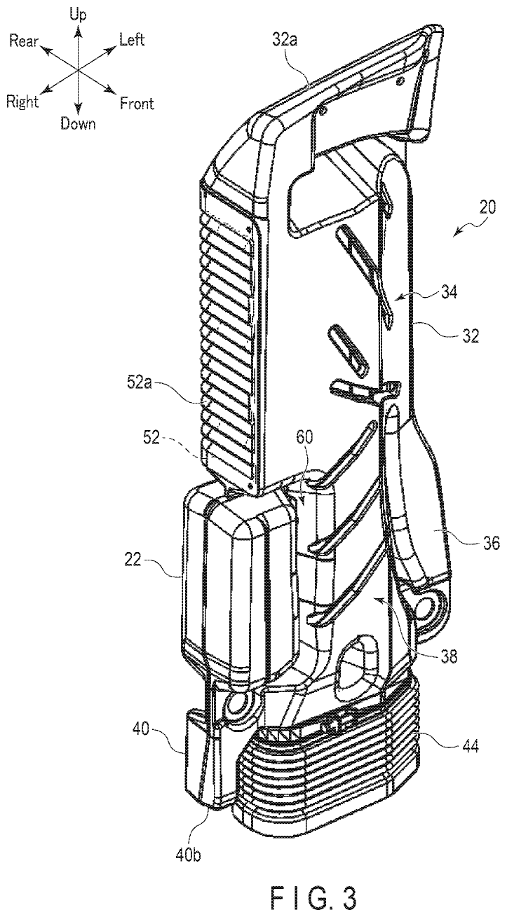

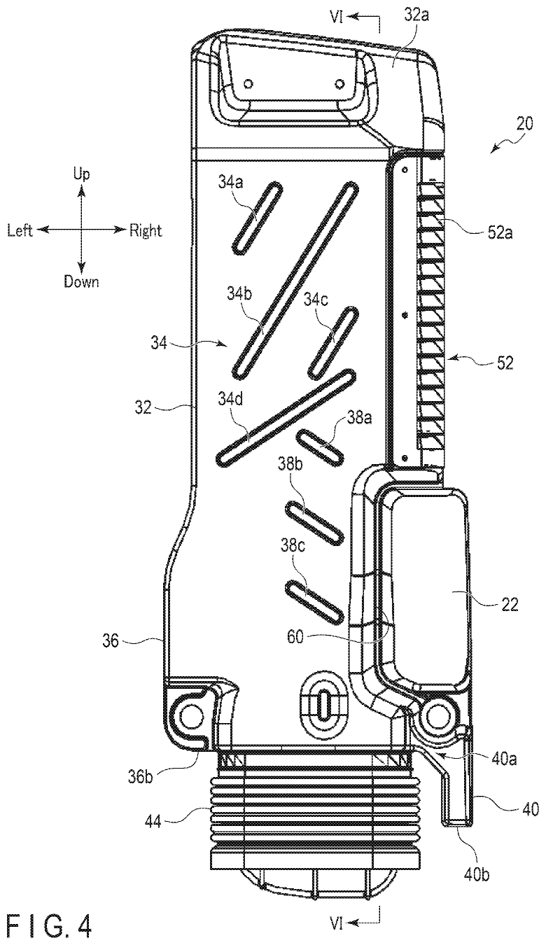

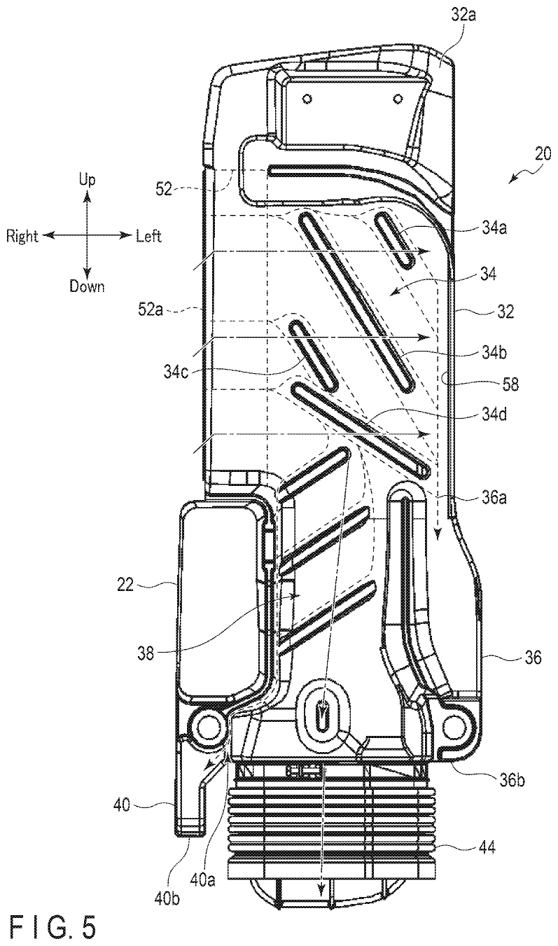

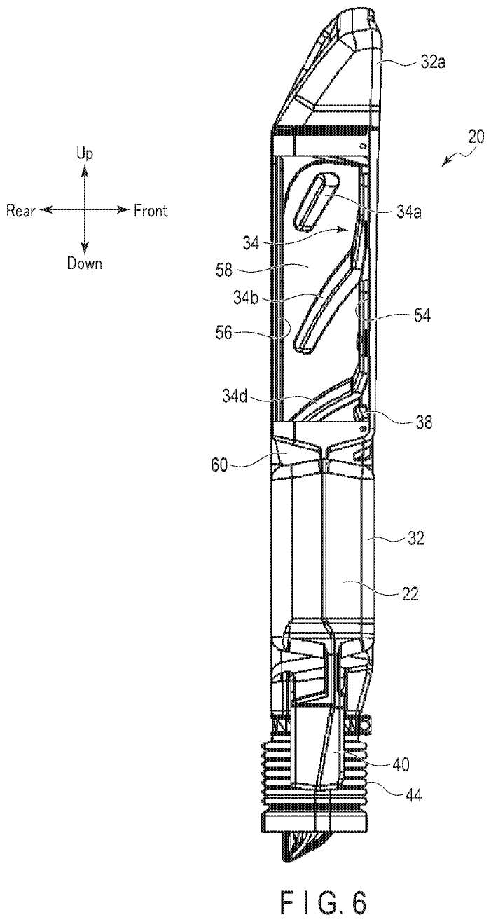

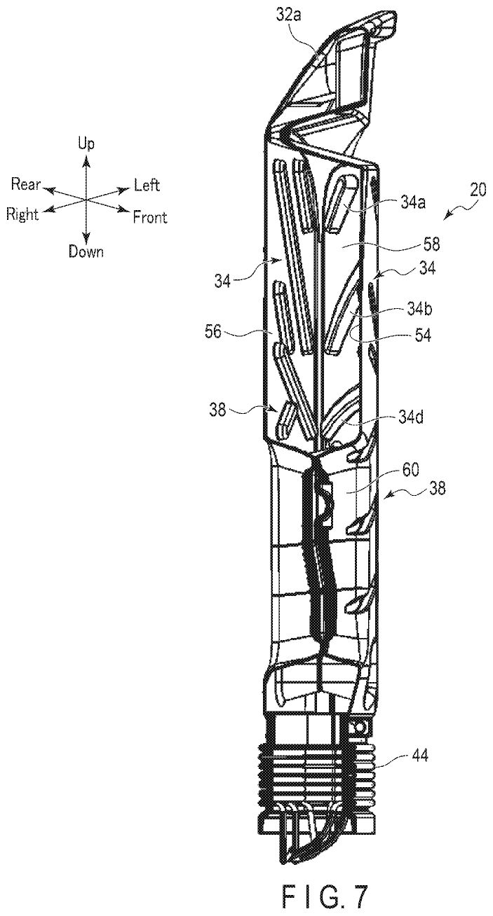

FIG. 1 is a schematic view showing part of the vehicle 10 in which the intake duct 20 is disposed on the right rear side of a cab 14. FIG. 2 is a schematic perspective view of the intake duct 20 as viewed from the right rear side of the vehicle 10 shown in FIG. 1. FIG. 3 is a schematic perspective view of the intake duct 20 as viewed from the right front side of the vehicle 10 shown in FIG. 1. FIG. 4 is a schematic view of the intake duct 20 shown in FIGS. 2 and 3 as viewed from the rear side. FIG. 5 is a schematic perspective view of the intake duct 20 shown in FIGS. 2 to 4 as viewed from the front side. In FIG. 5, a long dashed short dashed line indicates part of the air flow. In FIG. 5, a dashed line indicates part of the water flow. FIG. 6 is a schematic cross-sectional view taken along line VI-VI in FIG. 4. FIG. 7 is a schematic perspective view of the intake duct 20 shown in FIG. 6 as viewed from a slightly right front side with respect to FIG. 6.

The vehicle 10 shown in FIG. 1 is a cab-over type truck as an example. The vehicle 10 includes a frame 12, a cab 14 supported on the frame 12, an engine (internal combustion engine) 16 provided on the frame 12 below the cab 14, an air cleaner 18, the air intake duct 20 introducing air into the engine 16 through the air cleaner 18, and a resonator 22.

Examples of the engine 16 include a diesel engine. However, the type, form, and the like of the engine 16 are discretionary.

The air cleaner 18 is provided on the frame 12, for example. The air cleaner 18 has a structure in which air is introduced toward the engine 16 while preventing water and foreign matter in the air from being introduced to the engine 16.

The intake duct 20 can introduce air toward the air cleaner 18 and the engine 16 below the cab 14. The intake duct 20 is provided on one side in a vehicle width direction (left-right direction) on the back side of the cab 14 of the vehicle 10. In the present embodiment, an example in which the intake duct 20 is provided on the right side (one side) behind the cab 14 will be described.

In the present embodiment, an example in which the intake duct 20 is disposed on the right rear side (the rear side on one side) of the cab 14 will be described, but, depending on the arrangement of the engine 16, the air cleaner 18, and the like, it may also be preferable for the intake duct 20 to be disposed on the left rear side (the rear side on the other side) of the cab 14. In a case where the intake duct 20 is disposed on the left rear side of the cab 14, it is preferable that the intake duct 20 have a structure that is laterally inverted relative to a case where the intake duct 20 is disposed on the right rear side of the cab 14, for example, such that an intake port 52 is disposed toward the left side of the vehicle 10.

In the present embodiment, the intake duct 20 is provided above an inlet portion 18a of the air cleaner 18, on the back surface of the cab 14, and on the right side, which is one side in the left-right direction. In the present embodiment, the intake duct 20 is formed in a flat shape that is thin in the front-rear direction and is larger in the left-right direction than in the front-rear direction, and opens outward in the left-right direction of the vehicle 10. It is preferable that the intake duct 20 be formed to be larger in the up-down direction than in the left-right direction.

As shown in FIGS. 2 to 7, the intake duct 20 includes an intake duct main body 32, a first guide portion 34, a first tank (catch tank) 36, a second guide portion 38, a second tank (catch tank) 40, and a connection pipe 44.

The intake duct main body 32 is tubular and includes an intake port 52 that opens toward the right side in the present embodiment, which is the outside of the vehicle 10. The intake port 52 has, as an example, a substantially rectangular shape. The intake port 52 is spaced upward from the air cleaner 18 below the intake duct 20. The intake port 52 of the intake duct main body 32 draws air from the intake port 52 and introduces the air toward the air cleaner 18 and the engine 16 below the intake duct 20.

It is preferable that the intake port 52 not be formed at a position facing the surface of the vehicle 10 on the cab 14 side, or that the intake port 52 be formed with a small area. It is preferable that the opening amount of the intake port 52 toward the rear of the vehicle 10 be set to a small area, and that there be almost no formation of the intake port 52 toward the rear of the vehicle 10 or that the intake port be formed to have a small area. Note that it is acceptable that part of the intake port 52 opens toward the right oblique rear of the vehicle 10, not toward the rear of the vehicle 10 itself. Therefore, in the present embodiment, the intake duct main body 32 is formed such that air enters from the right side of the vehicle 10 through the intake port 52.

The intake port 52 is covered with a louver 52a that opens outward in the vehicle width direction. In the present embodiment, the louver 52a opens toward the lower right in the vehicle width direction. Because of the opening direction of the louver, the intake duct main body 32 allows air to enter the intake duct main body 32 through the intake port 52, while suppressing water such as rainwater from entering the intake duct main body 32 through the intake port 52 together with the air.

As shown in FIGS. 6 and 7, the intake duct main body 32 has, as inner walls around the intake port 52 in the horizontal direction, a first surface 54 on the cab 14 side, a second surface 56 facing the first surface 54 and on the side opposite to the cab 14 side, and a third surface 58 on the side opposite to the intake port 52 side.

For the sake of simplicity of description, the first surface 54 and the second surface 56 are described as being parallel or substantially parallel to a plane defined by up, down, left, and right in the present embodiment, but it is also preferable that the first surface 54 and the second surface 56 be appropriately curved surfaces or that the distance increase or decrease toward the right side. It is preferable that the distance between the first surface 54 and the second surface 56 be smaller than the distance between the intake port 52 and the third surface 58. Therefore, the intake duct main body 32 is formed in a flat tubular shape. As shown in FIGS. 2 to 7, the upper portion of the intake duct main body 32 is sealed by a cap 32a.

The first surface 54 and the second surface 56 are provided with a first guide portion 34 and a second guide portion 38 that guide air and water taken into the intake duct main body 32 through the intake port 52 downward from the right side (one side). Note that while it is preferable that the first guide portion 34 and the second guide portion 38 be provided on each of the first surface 54 and the second surface 56, it is also preferable that the first guide portion 34 and the second guide portion 38 be provided on at least one of the first surface 54 or the second surface 56. As an example, it is also preferable that the first guide portion 34 be provided only on the first surface 54 and the second guide portion 38 be provided only on the second surface 56, or that the first guide portion 34 and the second guide portion 38 be provided only on the first surface 54 or only on the second surface 56. It is also preferable that the first guide portion 34 and the second guide portion 38 be provided on the first surface 54, and that the first guide portion 34 or the second guide portion 38 be provided on the second surface 56. In this way, the first guide portion 34 may be provided on the inner wall of the intake duct main body 32, and the second guide portion 38 may be provided on the inner wall of the intake duct main body 32.

The first guide portion 34 has one or more first ribs (beads) 34a, 34b, 34c, and 34d in which the upper side is closer to the intake port 52 than the lower side. The first ribs 34a, 34b, 34c, and 34d on the first surface 54 and the first ribs 34a, 34b, 34c, and 34d on the second surface 56 face each other. Any one of the first rib 34a, 34b, 34c, and 34d may be used on the first surface 54 and the second surface 56.

As shown in FIGS. 6 and 7, part of the first guide portion 34 is provided on the third surface 58 on the left side opposite to the intake port 52 on the right side on the inner wall of the intake duct main body 32. In FIGS. 6 and 7, the ribs 34b, 34d, etc. extend, for example, on the first surface 54 and the third surface 58.

The amount of protrusion of the first ribs 34a, 34b, 34c, and 34d into the intake duct main body 32 relative to the first surface 54, and the amount of protrusion of the first ribs 34a, 34b, 34c, and 34d into the intake duct main body 32 relative to the second surface 56 and the third surface 58 are, for example, several millimeters or more, and can be appropriately set according to the relationship between the sizes of the first surface 54, the second surface 56, and the third surface 58, the distance between the first surface 54 and the second surface 56, the separation capability of water from air, and the like. The shapes including the lengths and widths of the first ribs 34a, 34b, 34c, and 34d on the first surface 54 and the first ribs 34a, 34b, 34c, and 34d on the second surface 56 can be set as appropriate.

The first ribs 34a, 34b, 34c, and 34d are provided on each of the first surface 54 and the second surface 56. The first ribs 34a, 34b, 34c, and 34d each have a shape that continuously decreases in height from the intake port 52 side toward the side opposite to the intake port 52. In the present embodiment, the first ribs 34a, 34b, 34c, and 34d are formed straight, but may be, for example, curved surfaces that are convex upward as long as they have a shape continuously decreasing in height from the intake port 52 side toward the side opposite to the intake port 52. The first ribs 34a, 34b, 34c, and 34d can each catch water such as rainwater and guide the water toward the wall (third surface 58) on the side opposite to the intake port 52 through the upper surfaces and the lower surfaces of the first ribs 34a, 34b, 34c, and 34d.

Among the first ribs 34a, 34b, 34c, and 34d provided on each of the first surface 54 and the second surface 56, the upper three ribs 34a, 34b, and 34c are substantially parallel to each other at equal intervals, and the fourth rib 34d from the top is closer to horizontal than the upper three ribs 34a, 34b, and 34c. Furthermore, among the upper three ribs 34a, 34b, and 34c of the first ribs 34a, 34b, 34c, and 34d, the rib 34b in the middle in the left-right direction has an upper end whose horizontal position aligns or substantially aligns with that of the rib 34a on the left side of the rib 34b, and a lower end whose horizontal position aligns or substantially aligns with that of the rib 34c on the right side of the rib 34b. Note that the upper end of the intake port 52 is located above the upper ends of the rib 34a and the rib 34b. Furthermore, the left end of the rib 34a and the left end of the rib 34b are not displaced from each other in the left-right direction, or are displaced from each other in the left-right direction only to a small extent, and are spaced apart from each other in the up-down direction. Similarly, the right end of the rib 34b and the right end of the rib 34c are not displaced from each other in the left-right direction, or are displaced from each other in the left-right direction only to a small extent, and are separated from each other in the up-down direction. Therefore, among the upper three ribs 34a, 34b, and 34c of the first ribs 34a, 34b, 34c, and 34d, the rib 34b in the middle in the left-right direction is formed to be longer than the rib 34a on the left side of the rib 34b and the rib 34c on the right side of the rib 34b.

The upper end of the rib 34d is located above the lower ends of the ribs 34b and 34c, and the right end of the rib 34d and the right end of the rib 34c are not displaced from each other in the left-right direction, or are displaced from each other in the left-right direction only to a small extent, and are separated from each other in the up-down direction. The lower end of the rib 34d is located below the lower ends of the ribs 34b and 34c, and is located on the left side of the left ends of the ribs 34a and 34b. The lower end of the rib 34d is located immediately above the inlet 36a of the first tank 36.

The lengths of the ribs 34a and 34c are substantially the same, and the rib 34d is shorter than the rib 34b and longer than the ribs 34a and 34c.

The horizontal positions of the lower left end of the rib 34d and the lower right end of a rib 38a, which will be described later, of the second guide portion 38 align or substantially align with each other. Furthermore, the horizontal positions of the lower end of the rib 34d and the lower end of the intake port 52 align or substantially align with each other.

In FIG. 6, the ribs 34a, 34b, and 34d are positioned such that the ends on the first surface 54 side are higher than the ends on the second surface 56 side. The ribs 34a, 34b, and 34d have a shape continuously decreasing in height from the first surface 54 side toward the second surface 56. It is preferable that the lower ends of the rib 34a, 34b, and 34d be located immediately above the inlet 36a of the first tank 36. Therefore, the ribs 34a, 34b, and 34d guide water entering the intake duct main body 32 toward the second surface 56 side.

In FIGS. 2 to 5, the ribs 34a, 34b, 34c, and 34d of the first guide portion 34 are shown as they appear on the outer peripheral surface of the intake duct main body 32. It is also preferable that part or all of the ribs 34a, 34b, 34c, and 34d of the first guide portion 34 be formed only on the inner peripheral surface (inner wall) of the intake duct main body 32, and not be formed on the outer peripheral surface (outer wall).

As shown in FIGS. 2 to 7, the intake duct main body 32 has a recess 60 below the intake port 52, in which a resonator 22 is disposed.

The first tank 36 is provided on the other side opposite to the one side and below the first guide portion 34. That is, the first tank 36 is provided on the opposite side of the recess 60 in the intake duct main body 32. The first tank 36 captures water when the water enters the first guide portion 34 in the intake duct main body 32 together with air from the intake port 52.

The second guide portion 38 is provided on the inner wall of the intake duct main body 32 below the first guide portion 34. The second guide portion 38 has one or more second ribs (beads) 38a, 38b, and 38c in which the lower side is closer to the intake port 52 than the upper side. The second ribs 38a, 38b, and 38c on the first surface 54 and the second ribs 38a, 38b, and 38c on the second surface 56 face each other. Any one of the second ribs 38a, 38b, and 38c may be used on the first surface 54 and the second surface 56.

The amount of protrusion of the second ribs 38a, 38b, and 38c into the intake duct main body 32 relative to the first surface 54, and the amount of protrusion of the second ribs 38a, 38b, and 38c into the intake duct main body 32 relative to the second surface 56 are, for example, several millimeters or more, and can be appropriately set according to the relationship between the sizes of the first surface 54 and the second surface 56, the distance between the first surface 54 and the second surface 56, the separation capability of water from air, and the like. The shapes including the lengths and widths of the second ribs 38a, 38b, and 38c on the first surface 54 and the second ribs 38a, 38b, and 38c on the second surface 56 can be set as appropriate.

The second ribs 38a, 38b, and 38c are provided on each of the first surface 54 and the second surface 56. The second ribs 38a, 38b, and 38c have a shape continuously increasing in height from the intake port 52 side toward the side opposite to the intake port 52. In other words, the second ribs 38a, 38b, and 38c have a shape continuously decreasing in height from the opposite side of the intake port 52 toward the intake port 52. The second rib 38a, 38b, and 38c can each catch air and water such as rainwater and guide the water toward the inner wall side of the recess 60 below the intake port 52 through the upper surfaces and the lower surfaces of the second ribs 38a, 38b, and 38c.

The second ribs 38a, 38b, and 38c provided on each of the first surface 54 and the second surface 56 are, for example, substantially parallel to each other at equal intervals. Each of the second ribs 38a, 38b, and 38c of the second guide portion 38 is formed shorter than each of the first ribs 34a, 34b, 34c, and 34d of the first guide portion 34.

Among the second ribs 38a, 38b, and 38c of the second guide portion 38, the upper rib 38a is provided between the left end and the right end of the first rib 34d of the first guide portion 34. Among the second ribs 38a, 38b, and 38c of the second guide portion 38, the right ends of the ribs 38a and 38b are vertically spaced apart from each other, and the right ends of the ribs 38b and 38c are vertically spaced apart from each other. The lower end of the lowermost rib 38c is disposed above the lowermost end of the inner wall of the recess 60.

The right ends (the intake port 52) of the second ribs 38a, 38b, and 38c may be located at any position as long as there is a gap for allowing water to pass between the right ends and the inner wall of the recess 60.

In FIGS. 2 to 5, the ribs 38a, 38b, and 38c of the second guide portion 38 are shown as they appear on the outer peripheral surface of the intake duct main body 32. It is also preferable that part or all of the ribs 38a, 38b, and 38c of the second guide portion 38 be formed only on the inner peripheral surface (inner wall) of the intake duct main body 32, and not be formed on the outer peripheral surface (outer wall).

The second tank 40 is provided below the recess 60 and below the second guide portion 38. Therefore, the second tank 40 is provided on the opposite side of the first tank 36 in the intake duct main body 32.

There is an overhanging portion between the inner wall of the recess 60 and the inlet 40a of the second tank 40. Therefore, it is preferable that the inner wall of the recess 60 have an appropriate hydrophilicity that causes the portion where the water flows along the inner wall of the recess 60 to reach the inlet 40a of the second tank 40 to exhibit a larger surface tension. The second tank 40 captures water flowing along the inner wall of the recess 60 when the water enters the second guide portion 38 together with air from the intake port 52.

As shown in FIGS. 2 to 7, the connection pipe 44 is provided at the lower end of the intake duct main body 32 and is disposed adjacent to the inner side in the left-right direction of the vehicle 10 relative to the second tank 40. The first tank 36 is disposed above the connection pipe 44. The connection pipe 44 is formed, for example, in a cylindrical shape that penetrates vertically and has a connection structure with the air cleaner 18. Therefore, the connection pipe 44 is provided at the lower end of the intake duct main body 32 and is connected to the air cleaner 18.

The resonator 22 is disposed outside the recess 60 of the intake duct main body 32. The resonator 22 attenuates and reduces sound during intake using the intake duct 20.

When the engine 16 is operated, air is taken into the intake duct main body 32 from the outside of the vehicle 10 through the intake port 52. The air is taken in from the intake duct (intake vertical duct) 20 on the right rear of the cab 14 of the vehicle 10, and the air is introduced to the engine (internal combustion engine) 16 through the air cleaner 18.

At this time, if it is rainy, water such as rainwater may be taken into the intake duct main body 32 together with the air. At this time, as shown in FIG. 5, it is assumed that air and water flow from the right intake port 52 of the intake duct main body 32 toward the left inner wall (third surface 58) of the intake duct main body 32.

The air passing through the right intake port 52 of the intake duct main body 32 flows toward the third surface 58, which is the left inner wall of the intake duct main body 32, as indicated by the long dashed short dashed line. Furthermore, the water indicated by the dashed line may also enter the intake duct main body 32 together with the air.

At this time, part of the water hits each of the first ribs 34a, 34b, 34c, and 34d of the first surface 54 and the second surface 56. The water is guided to the third surface 58 on the opposite side of the intake port 52 along the first rib 34a, 34b, 34c, and 34d. The inlet 36a of the first tank 36 is provided at a lower portion along a wall opposite to the intake port 52. The lower end of the rib 34d of the third surface 58 guides the water to the inlet 36a of the first tank 36.

Therefore, the water is accumulated in the first tank 36. Upon the water accumulated in the first tank 36 reaching a certain water level, the water head pressure becomes larger than a negative pressure of a drain hole 36b opened in the bottom surface of the first tank 36, and the water is drained from the drain hole 36b. Therefore, the water accumulated in the first tank 36 can be automatically drained.

Of the water hitting the first guide portion 34 in the intake duct main body 32 from the intake port 52, part of the water that cannot be guided to the first tank 36 on the lower left side is guided to the second guide portion 38 having the second ribs 38a, 38b and 38c set on the center, front, and rear surfaces of the intake duct main body 32. Furthermore, the water is guided from the intake port 52 to the second guide portion 38 in the intake duct main body 32.

At this time, part of the water hits the second ribs 38a, 38b, and 38c of the first surface 54 and the second surface 56. The water is guided to the inner wall of the recess 60 under the intake port 52 along the second ribs 38a, 38b, and 38c. The inlet 40a of the second tank 40 is provided below the recess 60. The water is guided to the inlet 40a of the second tank 40 along the inner wall of the recess 60.

Therefore, the water is accumulated in the second tank 40. Upon rainwater accumulated in the second tank 40 reaching a certain water level, the water head pressure becomes larger than a negative pressure of a drain hole 40b opened in the bottom surface of the second tank 40, and the water is drained from the drain hole 40b. Therefore, the water accumulated in the second tank 40 can be automatically drained.

In this way, if water such as rainwater flows from the right side of the intake duct main body 32 toward the left side through the intake port 52, the rainwater can be guided to the first tank 36 by the first guide portion 34 provided on each inner wall of the intake duct main body 32 on the cab 14 side and the side opposite to the cab 14 side, and the rainwater can be guided to the second tank 40 by the second guide portion 38 further provided below the first guide portion 34. Therefore, it is possible to suppress the inflow of the rainwater to the air cleaner 18.

In the present embodiment, there is a possibility that water will be drawn in addition to air from the intake port 52, which is laid out at the right end of the vehicle 10 and largely opens leftward, toward the left wall surface (third surface 58) in the intake duct 20. The opening of the intake port 52 to the rear is set to have a small area. The water drawn into the intake duct 20 from the intake port 52 flows along the ribs 34a to 34d set on the front and rear surfaces (the first surface 54 and the second surface 56) and the left wall surface (the third surface 58) in the intake duct main body 32 of the intake duct 20, and is accumulated in the first catch tank 36 set on the lower left of the intake duct 20. In this way, since the structure is such that the water drawn from the intake port 52 on, for example, the right side, which is one side in the left-right direction of the intake duct 20 of the vehicle 10, is guided to the first tank 36 on the left side of the intake duct 20, there is no impediment in the guide path of the water, and the water can be efficiently guided to the first tank 36. When the water level in the first tank 36 reaches a certain level, the water is automatically drained from the drain hole 36b opened in the bottom surface of the first tank 36.

Furthermore, in the intake duct 20, the water not guided to the first tank 36 at the lower left can be accumulated in the second tank 40 at the lower right of the intake duct 20 along the ribs 38a to 38c set at the center, front, and rear surfaces (the first surface 54 and the second surface 56) of the intake duct main body 32. As in the case of the first tank 36 at the lower left of the intake duct 20, when the water level reaches a certain level, the water is automatically drained from the drain hole 40b opened in the bottom surface of the second tank 40. The water drawn from the lower side of the intake port 52 on, for example, the right side, which is one side in the left-right direction of the intake duct 20 of the vehicle 10, tends to flow toward the second guide portion 38 rather than the first guide portion 34. At this time, since the structure is such that the water is guided to the second tank 40 on the right side of the intake duct 20, the water does not interfere with the guide path of the water toward the first tank 36 on the left side, thereby allowing the water to be efficiently guided to the second tank 40.

Therefore, according to the present embodiment, it is possible to provide an intake duct 20 for the vehicle 10 that may suppress the inflow of rainwater to the air cleaner 18 side below the intake duct 20, and the vehicle 10 having such an intake duct 20.

### Second Embodiment

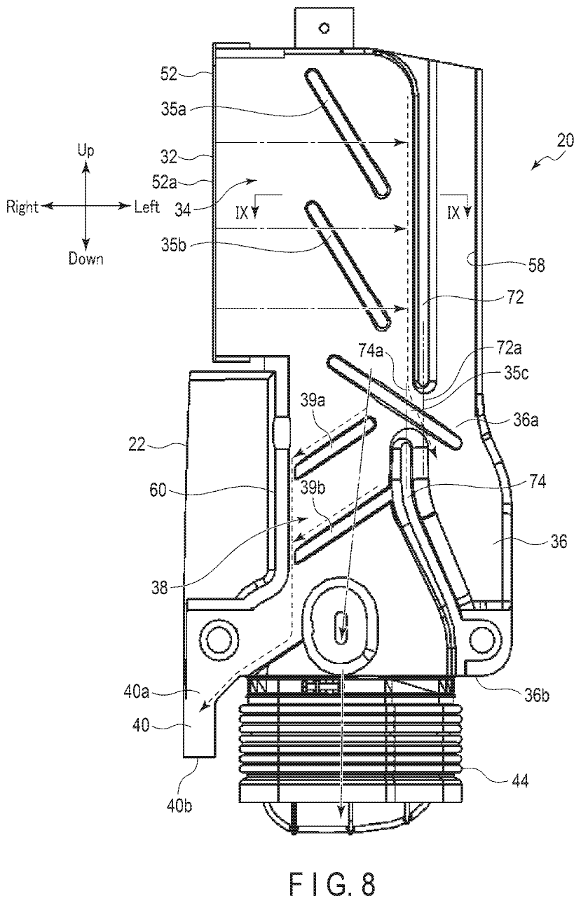

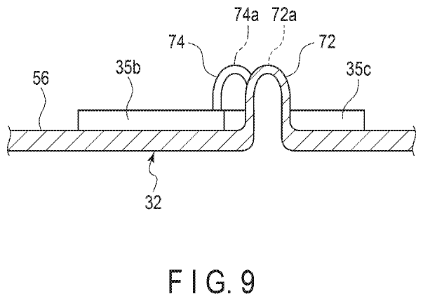

An air intake duct 20 of a vehicle 10 according to the second embodiment will be described with reference to FIGS. 8 and 9. The present embodiment is a modification of the first embodiment, and the same members or members having the same functions as the members described in the first embodiment are denoted by the same reference numerals as much as possible, and detailed description thereof will be omitted.

FIG. 8 is a schematic view of the intake duct 20 according to the present embodiment as viewed from the front side. FIG. 8 omits illustration of the cap 32a. FIG. 9 is a cross-sectional view taken along line IX-IX in FIG. 8. FIG. 9 is a cross-sectional view of the intake duct main body 32 on the second surface 56 side.

As shown in FIGS. 8 and 9, the second surface 56 of the intake duct main body 32 has an upper first bead (rib) 72 and a lower second bead (rib) 74. The first bead 72 and the second bead 74 are formed as protrusions protruding from the second surface 56 toward the inner side of the intake duct main body 32. In other words, the first bead 72 and the second bead 74 are formed as recessed grooves that are recessed inward when viewed from the outside of the intake duct main body 32.

As shown in FIG. 8, the first bead 72 extends vertically in the intake duct main body 32. The first bead 72 extends toward the inlet of the first tank 36. The direction in which the top of the first bead 72 extends is indicated by a long dashed double-short dashed line 72a. The second bead 74 is formed at a position closer to the leftmost wall of the first tank 36. The top portion of the upper portion of the second bead 74 extends in the up-down direction. The direction in which the upper portion of the second bead 74 extends is indicated by a long dashed double-short dashed line 74a.

When the positions of the long dashed double-short dashed lines 72a and 74a of the beads 72 and 74 and are compared, the first bead 72 is on the left side with respect to the upper end of the second bead 74. Therefore, the upper first bead 72 is located, with respect to the lower second bead 74, on the far side with respect to the intake port 52. The lower end of the first bead 72 and the upper end of the second bead 74 are vertically spaced apart from each other. Therefore, the inlet 36a of the first tank 36 can be disposed immediately below the first bead 72, and water can be easily poured into the first tank 36 through the inlet 36a of the first tank 36.

The first guide portion 34 shown in FIG. 8 has three ribs 35a, 35b, and 35c. The ribs 35a and 35b have substantially the same length and are disposed substantially in parallel. The left end positions and the right end positions of the ribs 35a and 35b are spaced apart from each other in the up-down direction and are aligned with each other. The horizontal direction of the lower end of the rib 35a aligns or substantially aligns with that of the upper end of the rib 35b.

The lowermost rib 35c of the first guide portion 34 is inclined to be closer to the horizontal than the ribs 35a and 35b. The upper end of the rib 35c is disposed below the lower end of the rib 35b. The right end of the rib 35c is located between the right end and the left end of each of the ribs 35a and 35b. The left end of the rib 35c is located closer to the left end of the inner wall of the intake duct main body 32 than the first bead 72. In FIG. 8, the left end (lower end) of the rib 35c is located below the upper end of the second bead 74.

The second guide portion 38 has two ribs 39a and 39b. The ribs 39a and 39b are substantially parallel to each other. The horizontal position of the upper end of the upper rib 39a is between the upper end and the lower end of the rib 35c of the first guide portion 34. The horizontal position of the upper end of the upper rib 39a aligns or substantially aligns with that of the upper end of the second bead 74. Here, the upper end of the rib 39a and the upper end of the second bead 74 are separated from each other in the left-right direction. The left-side end of the rib 39a is disposed at a position on the right side of the left-side ends of the ribs 35a and 35b of the first guide portion 34. The right-side end of the rib 39a is disposed at a position on the right side of the right-side ends of the ribs 35a and 35b of the first guide portion 34.

The left end of the rib 39b is disposed at a position vertically spaced apart from the left ends of the ribs 35a and 35b of the first guide portion 34. The right end of the rib 39b is disposed at a position vertically spaced apart from the right end of the rib 39a. The left end (upper end) of the rib 39b is disposed at a position lower than the upper end of the second bead 74.

In this manner, the ribs 35a, 35b, and 35c of the first guide portion 34 may be disposed in a manner different from the ribs 34a to 34d of the first guide portion 34 described in the first embodiment. Similarly, the ribs 39a and 39b of the second guide portion 38 may be disposed in a manner different from the ribs 38a to 38d of the second guide portion 38 described in the first embodiment.

As shown in FIG. 8, it is assumed that air and water flow from the right intake port 52 of the intake duct main body 32 toward the left inner wall (third surface 58) of the intake duct main body 32.

The air passing through the right intake port 52 of the intake duct main body 32 flows toward the third surface 58, which is the left inner wall of the intake duct main body 32, as indicated by the long dashed short dashed line. Furthermore, the water indicated by the dashed line may also enter the intake duct main body 32 together with the air.

At this time, part of the water hits each of the first ribs 35a, 35b, and 35c of the first surface 54 and the second surface 56. The water is guided to the first bead 72 on the opposite side of the intake port 52 along the first rib 35a, 35b, and 35c. The water then flows downward along the first bead 72.

The inlet 36a of the first tank 36 is provided on the lower side of the first bead 72 on the opposite side of the intake port 52. Therefore, the water is accumulated in the first tank 36.

Of the water hitting the first guide portion 34 in the intake duct main body 32 from the intake port 52, part of the water that cannot be guided to the first tank 36 on the lower left side is guided to the second guide portion 38 having the second ribs 39a and 39b set on the center, front, and rear surfaces of the intake duct main body 32. Furthermore, the water is guided from the intake port 52 to the second guide portion 38 in the intake duct main body 32.

At this time, part of the water hits each of the second ribs 39a and 39b of the first surface 54 and the second surface 56. The water is guided to the inner wall of the recess 60 below the intake port 52 along the second ribs 39a and 39b. The inlet 40a of the second tank 40 is provided at a lower portion of the recess 60. The water is guided to the inlet 40a of the second tank 40 along the inner wall of the recess 60. Therefore, the water is accumulated in the second tank 40.

In this way, if water such as rainwater flows from the right side of the intake duct main body 32 toward the left side through the intake port 52, the rainwater can be guided to the first tank 36 by the first guide portion 34 provided on each inner wall of the intake duct main body 32 on the cab 14 side and the side opposite to the cab 14 side, and the rainwater can be guided to the second tank 40 by the second guide portion 38 further provided below the first guide portion 34. Therefore, it is possible to suppress the rainwater that may flow into the air cleaner 18.

Therefore, according to the present embodiment, it is possible to provide an air intake duct 20 for the vehicle 10 that can suppress the inflow of water to the air cleaner 18 side below the air intake duct 20, and the vehicle 10 having such an air intake duct 20.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An air intake duct comprising:
an intake duct main body provided on one side in a left-right direction on a back side of a cab of a vehicle,
the intake duct main body including an intake port that opens toward the one side of the vehicle, and drawing air from the intake port to introduce the air toward an engine on a lower side of the cab;
a first guide portion provided on an inner wall of the intake duct main body,
the first guide portion including one or more first ribs in which an upper side is closer to the intake port than a lower side,
the first ribs catching water taken into the intake duct main body through the intake port from the one side and guiding the water downward;
a first tank provided on an other side opposite to the one side and below the first guide portion, and accumulating the water caught and guided by the first guide portion upon entry of the water from the intake port;
a second guide portion provided below the first guide portion on the inner wall of the intake duct main body,
the second guide portion including one or more second ribs in which a lower side is closer to the intake port than an upper side,
the second ribs catching the water taken into the intake duct main body through the intake port from the one side and guiding the water downward; and
a second tank provided on the one side and below the second guide portion, and accumulating the water caught and guided by the second guide portion upon entry of the water from the intake port.

2. The air intake duct according to claim 1, wherein
the first guide portion is provided on each of a first surface on a side of the cab and a second surface facing the first surface and on a side opposite to the side of the cab, on the inner wall of the intake duct main body.

3. The air intake duct according to claim 2, wherein
a protrusion protruding toward the cab is provided at a position farther from the intake port than the first guide portion, on the first surface of the inner wall of the intake duct main body, and
the protrusion extends toward an inlet of the first tank.

4. The air intake duct according to claim 2, wherein
a third surface on a side opposite to a side of the intake port is provided with ribs having a shape continuously decreasing in height from the first surface toward the second surface, on the inner wall of the intake duct main body.

5. The air intake duct according to claim 1, wherein
the second guide portion is provided on each of a first surface on a side of the cab and a second surface facing the first surface and on a side opposite to the side of the cab, on the inner wall of the intake duct main body.

6. A vehicle comprising:
the air intake duct according to claim 1; and
the cab in which the intake duct is provided.
